(19) United States
(12) Patent Application Publication
(10) Pub. No.: US 2017/0020095 A1
(43) Pub. Date: Jan. 26, 2017

(54) PLANT GROWING APPARATUS, SYSTEMS AND METHODS

(71) Applicants: Stephen Donald Kamholz, Huntington Beach, CA (US); James Leych Lau, Tustin, CA (US)

(72) Inventors: Stephen Donald Kamholz, Huntington Beach, CA (US); James Leych Lau, Tustin, CA (US)

(21) Appl. No.: 14/807,842

(22) Filed: Jul. 23, 2015

(51) Int. Cl. A01G 31/02; A01G 1/00

(52) U.S. Cl. CPC A01G 31/02; A01G 1/001

(57) ABSTRACT

A system of growing plants having a coco pod having at least one layer of coconut coir fiber and at least a hole for receiving a plant's roots, a nutrient solution, and a container for holding the coco pod and the nutrient solution, such that the coco pod is at least partially immersed in the nutrient solution and the plant's roots are continuously exposed to the nutrient solution and substantially protected from sunlight.

### CROSS-REFERENCE TO RELATED APPLICATIONS

Not applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The invention relates generally to horticulture, and more particularly to the technical field of indoor or outdoor plant growing media systems and methods.

2. Description of the Related Art

Hydroponic growing involves growing a terrestrial plant suspended in a container to allow the roots to be submerged in a liquid nutrient solution with or without added aeration to promote root development. Deep water culture or re-circulating deep water culture such as this can allow for a constant abundant supply of nutrients to the roots. However, an issue with this method of hydroponic growing is that microbial, bacterial, algal, or fungal infection may attack the root zone, when unsterile or improper environmental parameters are used. This can especially appear to be true when the environment and liquid temperature are above 75 degrees Fahrenheit. Once introduced, microbial, bacterial, algal, or fungal infection may be exacerbated by sunlight entering the solution, apparently due to prevention of oxygen being supplied to the roots.

Chillers may be used to prevent the hydroponic growing system from rising above 68 degrees Fahrenheit in order to minimize the growth of microbial or fungal growth on the root system. However, this solution may be expensive.

An ebb and flow method may be used for hydroponic growing, in which the hydroponic nutrient solutions are flooded to the root system for a short period of time, and then allowed to ebb away. This method can be high maintenance since the cycles of ebb and flow may need to be repeated several times a day, and also appears to be inefficient in its delivery of nutrients to the root system. Additionally, microbial and fungal infection may still grow while using this method, so another problem is that the re-circulating solution may need to be filtered and sterilized, adding more cost.

Problems associated with some horticultural growing media are that some may eventually appear to suffocate the root system, some do not appear to be able to structurally support the roots, and some do not appear to have anti-bacterial or anti-fungal properties.

Therefore, there is a need for a deep water hydroponic growing media that is simple to use, low cost, low maintenance, efficient, and prevents the growth of microbes, bacteria, algae, and fungi when the nutrient solution is not being recirculated, and the root system is continuously submerged in the nutrient solution for best nutrient absorption by the roots, and without the need for chillers.

The problems and the associated solutions presented in this section could be or could have been pursued, but they are not necessarily approaches that have been previously conceived or pursued. Therefore, unless otherwise indicated, it should not be assumed that any of the approaches presented in this section qualify as prior art merely by virtue of their presence in this section of the application.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment, a coco pod made of coconut growing media bonded with natural latex (hereinafter, “coco pod,” or “coconut coir growing media system,”) is provided. A growing plant (hereinafter, “plant,” or “seedling”) may be placed into the coco pod and both the plant and coco pod may be submerged in a nutrient solution. A system for aeration of the roots of the plant may be used. Thus, an advantage is that the coir has anti-algal, anti-microbial, and anti-fungal properties to prevent infection, to plant's root system. Another advantage is that the coir bonded with latex provides support to the plant's developing root system. Another advantage is that the aeration provides oxygen to the plant's root system.

In another exemplary embodiment, the coco pod may be cylindrical or cubed, or any other shape, such as, for example, hexagonal, octagonal, spherical, pyramidal, triangular, trapezoidal, or any other shape deemed suitable.

In another exemplary embodiment, a single air pump or multiple air pumps may be used to provide aeration to multiple coco pods, each with their own nutrient solution. A single air pump or multiple air pumps may also be used to provide aeration to multiple coco pods all with a common nutrient solution.

In another exemplary embodiment, the coco pod growing media may be converted into a soil growth system by placing the entire coco pod with the plant and its growing roots system into the soil. Thus, an advantage is that plants may be grown in hydroponic or soil systems, or grown in a hydroponic system followed by growth in a soil system.

The above embodiments and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 illustrates a top perspective view of a coco pod cylinder, according to an embodiment.

FIG. 2 illustrates a cross-sectional side view of a coconut coir growing media system including the coco pod cylinder of FIG. 1.

FIG. 3 illustrates an alternative embodiment of the coconut coir growing media system of FIG. 2.

FIG. 4 illustrates a top perspective view of a single air pump providing aeration to multiple independent growing containers, according to an embodiment.

FIG. 5 illustrates a top perspective view of a coco pod cube, according to an embodiment.

FIG. 6 illustrates a top view of the coco pod cube of FIG. 5.

FIG. 7 illustrates a cross-sectional side view of the coco pod cube of FIG. 5.

FIG. 8 illustrates a top perspective view of coco pod cubes of FIG. 5 arranged in a single tray with air provided by air pumps to each individual cube, according to an embodiment.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

For the following description, it can be assumed that most correspondingly labeled structures across the figures (e.g., 12 and 42, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

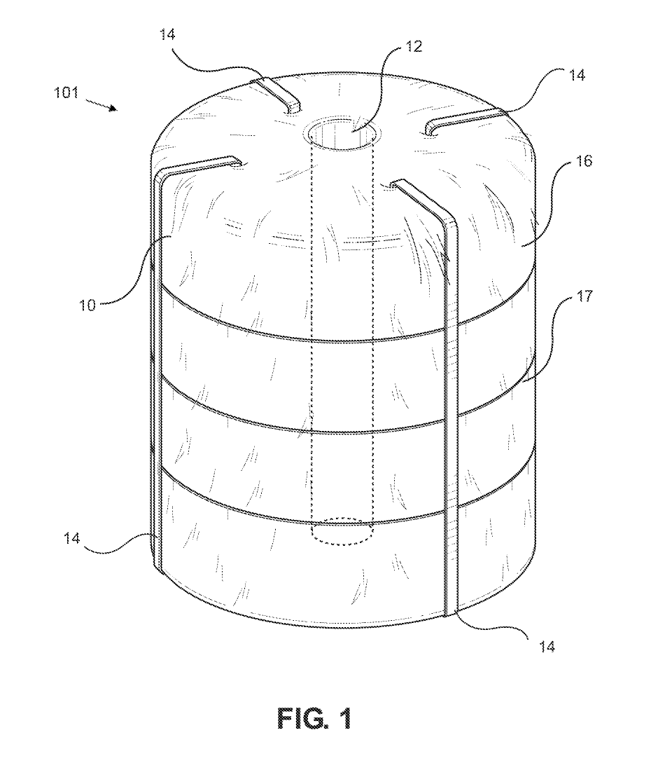

FIG. 1 illustrates a top perspective view of a coco pod cylinder 101, according to an embodiment. The coco pod cylinder 101 is preferably made up of coconut coir growing media 10 and may have a center hole 12 and may have a monofilament 14. The coconut coir growing media 10 may be made of coconut coir fiber woven and held together with natural latex (not shown). The coconut coir growing media 10 may be constructed in single layers 16 of coconut coir fiber bonded with natural and porous latex, and the layers may be stacked and further bonded with natural and porous latex on top of each other to achieve a desired height. Once the desired height is obtained, a monofilament 14 made of string or any material deemed suitable may be stitched through the top of the growing media 10 through all layers, exiting at the bottom of the coconut growing media 10 and tied to further strengthen the coco pod.

The center hole 12 may be circular or any other suitable shape, and may preferably be vertical, and may extend continuously from the top layer to the bottom layer of the coconut coir growing media 10. The coconut coir growing media 10 may be assembled by stacking single layers of latex bonded coconut coir media 16 on top of each other. Again, the stacks may be held together with latex bond 17 and further strengthened with monofilaments 14 around the circumference of the coco pod cylinder 101 as shown.

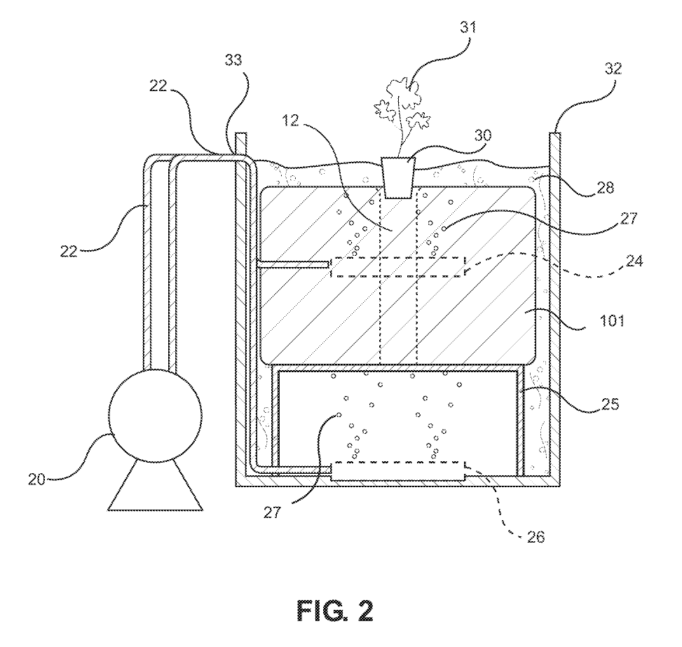

FIG. 2 illustrates a cross-sectional side view of a coconut coir growing media system including the coco pod cylinder 101 of FIG. 1. The coconut coir growing media system may include a container 32. The coco pod 101 may sit either at the bottom of the container 32, or on a frame 25 which may elevate the coco pod 101 above the bottom of the container 32. The container 32 may be any deemed suitable for holding the coconut coir growing media 10, such as, for example, buckets or other similar containers.

The system may include an external air pump 20. In one exemplary embodiment, each air pump 20 may include two air hoses 22. The container 32 may have an opening 33 for air hoses 22 to go through. Each air hose 22 may be connected to an air stone diffuser as indicated by 24 and 26, respectively. An air stone diffuser 24 may be placed inside of the system, such as, for example, in the middle of the coco pod 101, and another air stone diffuser 26 may be placed at the bottom of the container 32, outside of the coco pod 101 or at the bottom of the coco pod 101. The air pump 20 may cause the air bubbles 27 to aerate a nutrient solution (hereinafter “nutrient solution” or “liquid growing medium”) 28 and the coco pod 1. A horticultural starter cube 30 with, for example, a seedling 31 may be placed onto the opening 12 of the coco pod 101. The roots (not shown) of the seedling 31 may therefore be protected from sunlight by the mesh structure of the coco pod 101. Thus, an advantage is that exposure of the nutrient solution 28 and roots to sunlight may be decreased, which may help prevent bacterial or fungal growth.

The air pump 20 may be run continuously, such that the nutrient solution 28 and the coco pod 101 will be continuously aerated. The air hoses 22 may preferably be flexible. If multiple air hoses 22 are used, they may be of equal dimensions to equalize the air pressure amongst all the air stone diffusers 24 and 26.

A water line with a float (not shown) may be installed at the opening 33 to maintain the solution level. The water line may therefore replenish the water level, which may be lowered due to plant absorption of liquid or from evaporation. Thus an advantage is that no changing out of the solution is needed. A user may choose to measure and replenish the nutrient concentration as needed.

The coco pod coconut coir growing media of the coco pod cylinder 101 may preferably have a porous structure that allows for aeration of the plant 31 by the air diffusers 24 and 26. Therefore, an advantage is that developing roots of a plant 31 grown in the coco pod 101 will preferably have a dark, moist environment for healthy growth, and oxygen from the air diffusers 24 and 26. The coco pod cylinder 101 may also provide a structurally stable foundation for the growing plant 31. Another advantage is that when submerged in the liquid growing medium 28 of the growing system, the coconut coir (e.g., husk fibers of the coconut plant Cocos nucifera) may have anti-microbial and anti-fungal properties. Research appears to support these properties of the coconut coir.

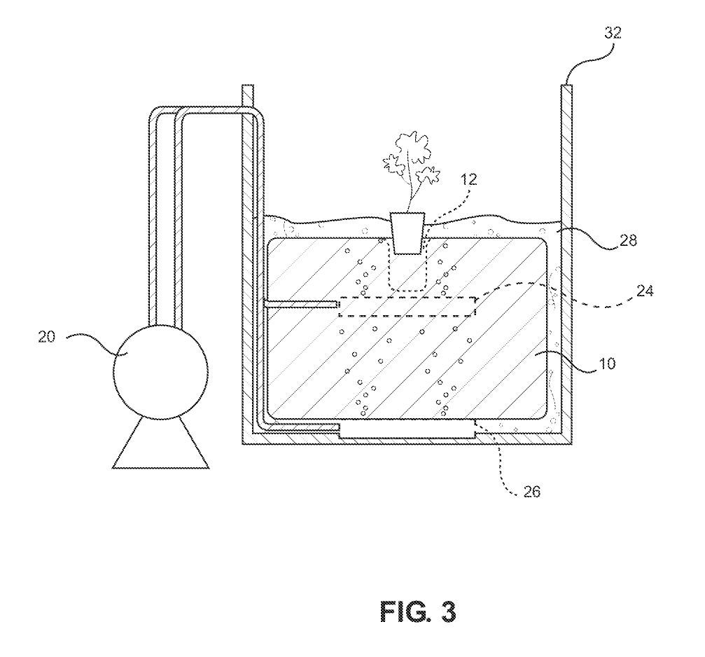

FIG. 3 illustrates an alternative embodiment of the coconut coir growing media system of FIG. 2 in which a coco pod 10 may rest on top of an air stone diffuser 26 at the bottom of a container 32. In another alternative embodiment, the center hole 12 may be only partially through the coco pod 10.

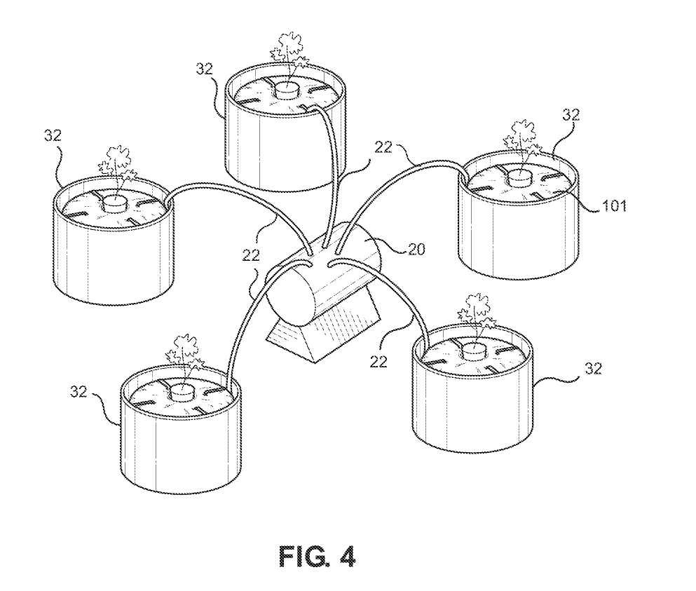

FIG. 4 illustrates a top perspective view of a single air pump 20 providing aeration to multiple independent growing containers 32, according to an alternative embodiment of the coconut coir growing media system shown in FIG. 2. As shown, each container 32 may have its own coco pod cylinder 101. Each container may also have its own nutrient solution as shown in FIG. 2

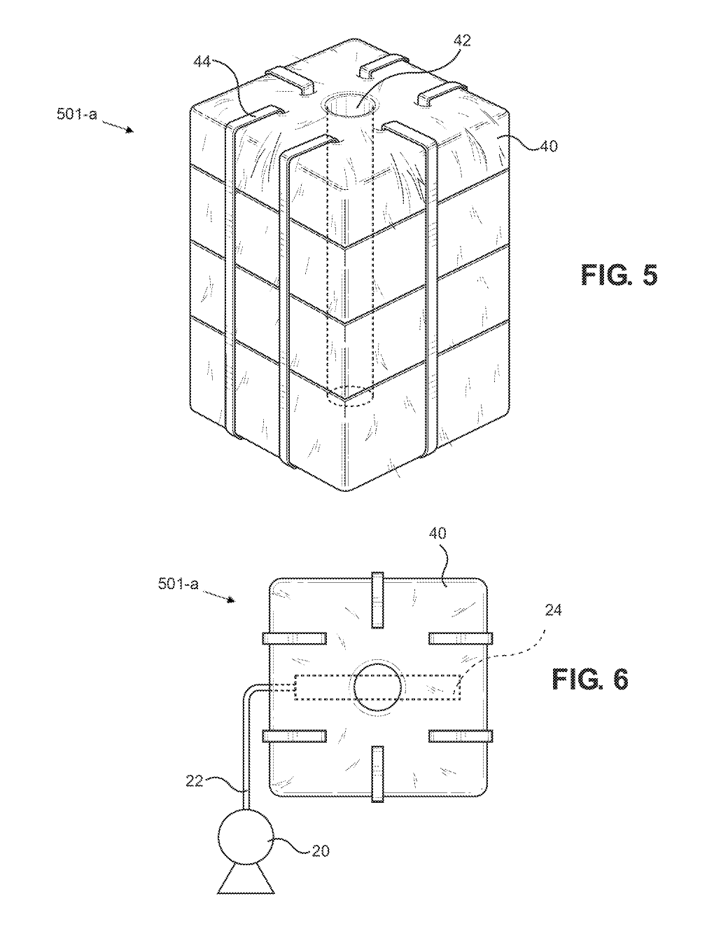

FIG. 5 illustrates a top perspective view of a coco pod cube 501-a, according to an alternative embodiment of the coco pod cylinder 101 shown in FIG. 2. The cube shaped coconut coir growing media 40 may have a center hole 42 with monofilaments 44. The center hole 42 may be circular or any other suitable shape, may preferably be vertical and may extend continuously from the top layer to the bottom layer of the coconut coir growing media 40, or alternatively may extend partially down without reaching the bottom. The coconut coir growing media 40 may be assembled by stacking single layer coconut coir media on top of each other and may be held together by latex as described earlier when referring to FIG. 1 and may also be held together with monofilaments 44.

FIG. 6 illustrates a top view of the coco pod cube 501-a of FIG. 5. An air pump 20 may be used with the coco pod cube 501-a, and an air hose 22 connected to the air pump 20 may provide aeration to the coconut coir growing media system. The coconut coir 40 may preferably have a porous structure that allows for aeration from an internal air stone diffuser 24 and may also receive aeration from an external air stone diffuser (see 26 in FIGS. 2-3) connected to an air hose 22.

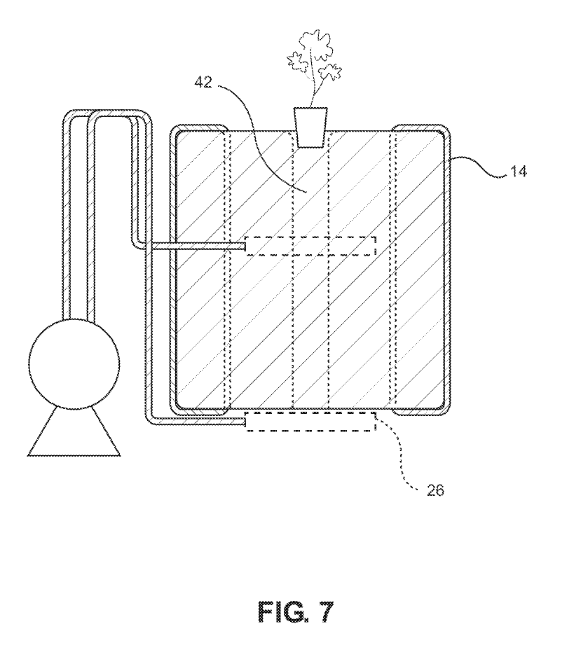

FIG. 7 illustrates a cross-sectional side view of a coconut coir growing media system including the coco pod cube 501-a of FIG. 5. The coco pod cube 501-a may be held together with one or more monofilaments 14 and may rest on an air diffuser stone 26. As shown, and as earlier described when referring to FIG. 1, the monofilament 14 may be stitched through the top of the coconut coir fibers and through all the growing media layers and exit the bottom of the growing media and may be tied securely. The center hole 42 may extend vertically to the bottom of the coco pod cube 501-a as shown, or extend only partially to the bottom as stated earlier when referring to the previous embodiments.

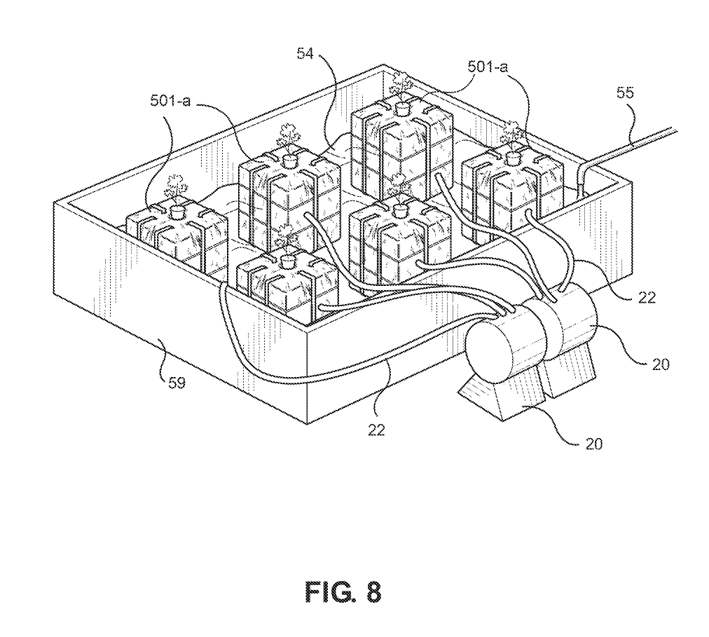

FIG. 8 illustrates a top perspective view of an embodiment of a coco pod cube hydroponic growing system wherein a single air pump 20 may provide aeration to multiple coco pod cubes 501-a. Again, a coco pod cube 501-a may rest on individual rectangular containers, similarly as in FIG. 4, or in a large rectangular tray 59 as shown in FIG. 8. A single air pump 20 or multiple air pumps 20 may be used to supply aeration to the individual coco pod cubes 501-a through air hoses 22. The nutrient solution 54 may be common to all the coco pod cubes 501-a in a tray 59. A water line 55 may be included to maintain the solution level in the tray 59.

The nutrient solution 54 and the pH of the solution 54 may be checked as needed by the user.

In another alternative embodiment, instead of individual coco pod cubes 501-a placed side by side in a large tray 59, a large rectangular block of coco pods having a plurality of smaller holes cut out for each seedling may be used. A plurality of air stones may then be inserted inside the larger rectangular coco pod to provide aeration. In another alternative embodiment, the use of air pumps and air stones for aeration may be optional, and any other suitable means of aerating the nutrient solutions may be used. In another alternative embodiment, there may be applications where no aeration is needed and in such cases, no air pumps may be used, or no air stones may be used with the coco pod system.

As an example, the coco pod, which may be of any suitable shape, may range in thickness from 6-12 inches. The hole for a coco pod cylinder may, for example, vary from ¼-2 inches depending on the application. The hole for a coco pod cube may, for example, vary from ½-2.5 inches in diameter or may for example be square-shaped, or any other suitable shape. The container may, for example, range between 4-12 inches in diameter and may, for example, be 4-12 inches in height. The air hoses used with the system may, for example, have dimensions of an outer diameter of 0.250 inch and an inner diameter of 0.170 inch. The monofilament may, for example, be able to withstand 10-28 pounds of weight, and may, for example, be resistant to corrosion in a solution of liquid nutrients. The coco pod may, for example, have no less than 6 stitches using the monofilament. Any tray used to hold single or multiple coco pods may, for example, have dimensions of a width of 4-72 inches and a length of 4-72 inches and a height of 4-12 inches. The amount of nutrient solution in a container may, for example, be 3 parts to every 5 parts capacity of the container. The coco pods may, for example, be biodegradable, and may be 100% natural. The coco pods may be converted into use with a soil growing system at any time, for example.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

As used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims. Use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the embodiments and examples shown should be considered as exemplars, rather than limitations on the apparatus and procedures disclosed or claimed. Although many of the examples involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the described methods. Acts, elements and features discussed only in connection with one embodiment are not intended to be excluded from a similar role in other embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and/or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

What is claimed is:

1. A system of growing plants comprising a coco pod having at least one layer of coconut coir fiber and at least a hole for receiving a plant's roots, a nutrient solution, and a container for holding the coco pod and the nutrient solution, such that the coco pod is at least partially immersed in the nutrient solution, wherein the plant's roots are continuously exposed to the nutrient solution and substantially protected from sunlight.

2. The system of claim 1, wherein the coco pod has four layers and wherein the coco pod is shaped as a cylinder.

3. The system of claim 1, wherein the coco pod has one central hole.

4. The system of claim 3, wherein the central hole extends from a top only partially toward a bottom of the coco pod.

5. The system of claim 1, wherein the coco pod comprises an air diffuser.

6. The system of claim 5, wherein the coco pod comprises an air stone diffuser.

7. The system of claim 1, further comprising at least an air diffuser within the container.

8. The system of claim 7 further comprising a means for aeration of the nutrient solution comprising at least one air pump, at least one air hose having a first end and a second end, the first end being connected to the air pump and the second end being connected to the at least an air diffuser, such that aeration is provided to the nutrient solution inside the container.

9. The system of claim 1 wherein the coconut coir fibers are held together using natural latex and, when the coco pod has more a plurality of layers, they are also held together using natural latex and further strengthened with at least one monofilament.

10. The system of claim 1 further comprising a water line used to maintain the nutrient solution at a desired level.

11. The system of claim 1 wherein the amount of liquid nutrient solution is 3 parts to every 5 parts capacity of the container.

12. The system of claim 1 wherein the hole extends throughout the height of the coco pod.

13. A method for horticulture in the context of using a system comprising a coco pod having at least one layer of coconut coir fiber and at least a hole for receiving a root system of a plant, a nutrient solution, and a container for holding the coco pod and the nutrient solution, comprising the steps of placing the root system of the plant in the hole and submerging the root system and the coco pod in the nutrient solution.

14. The method of claim 13 wherein the system further comprises a means for aerating the nutrient solution.

15. The method of claim 13 further comprising the steps of moving the coconut coir fiber and plant out of the nutrient solution and placing the coconut coir fiber and the root system of the plant into a soil system.
